(19) United States
(12) Patent Application Publication
(10) Pub. No.: US 2010/0084219 A1
(43) Pub. Date: Apr. 8, 2010

(54) MUFFLER INSULATING ELEMENT, MUFFLER AND METHOD OF PRODUCING A MUFFLER

(76) Inventor: Uwe Troeger, Langweid (DE)

Correspondence Address: PAMELA A. KACHUR, 577 W Santee Drive, Greensburg, IN, 47240, US

(21) Appl. No.: 12/529,398

(22) PCT Filed: Feb. 12, 2008
(86) PCT No.: PCT/EP2008/001054

§ 371 Date: Dec. 1, 2009

(30) Foreign Application Priority Data
Mar. 6, 2007 (DE) 102007010814.3

(51) Int. Cl. F01N 1/24; B32B 38/04

(52) U.S. Cl. 181/256; 428/34.5; 156/256

(57) ABSTRACT

A muffler insulating element comprises a mat of interconnected fibers. The mat has a constant density and at least two sections of different thicknesses. A muffler having such an insulating element and a method of producing a muffler are furthermore described.

### RELATED APPLICATION

This application is the U.S. national phase of PCT/EP2008/001054, filed Feb. 12, 2008, which claims priority to German Application DE 10 2007 010 814.3, which was filed Mar. 6, 2007.

### FIELD OF THE INVENTION

The invention relates to a muffler insulating element, a muffler and a method of producing a muffler.

### BACKGROUND OF THE INVENTION

In absorption type mufflers, insulating or absorption materials, such glass fibers or basalt rock wool for example, are used which are usually in the form of wool, i.e. of individual fibers, or in the form of foil packets filled with fibers. The use of thin fiber mats is also known in this context. In special housing shapes, three-dimensional molded parts made of absorbing fibers are used which are connected to form dimensionally stable components by means of a chemical binder without an absorbing effect such as phenolic resin. When the muffler provided with the molded part is put into operation for the first time in the vehicle, the binder is burned off due to the high exhaust gas temperature, whereas the fibers remain which are now adapted to absorb the occurring sound waves. FIG. 1 shows a molded part 100 according to the prior art.

The drawbacks of these molded parts consist in the comparatively costly manufacture, the high consumption of energy (phenolic resin must cure for approximately two hours at a temperature of about 200° C. to 300° C.), and the severely restricted shaping of the molded parts (sharp edges, for example, cannot be manufactured at all). There is also the fact that an additional chemical substance is required which contains formaldehyde before its curing. Furthermore, there is a risk that because the exhaust gas temperatures are too low, the binder is not completely burned off when the muffler is put into operation for the first time, whereby regions in the muffler are produced which do not contribute to the absorption. In addition, as can be seen in FIG. 1, fibers 102 may be present which are not fixed by the binder and get into the region of weld seams and can thus reduce their quality, which creates problems when the muffler is mounted.

In contrast thereto, the invention provides an insulating element, a muffler, and a method of producing a muffler avoiding the drawbacks known from the prior art.

### SUMMARY OF THE INVENTION

According to a first aspect of the invention, a muffler insulating element is provided which comprises a mat that includes interconnected fibers. The mat has at a constant thickness, at least two sections of different thicknesses. Owing to the sections of different thicknesses, a three-dimensional shape of the insulating element is obtained which can thus replace the molded parts of the prior art. Since the manufacture of mats is easier than the manufacture of molded parts, the muffler insulating element according to the invention is particularly cost-effective. Here, sharp edges and smooth contours are also possible. Due to the constant density of the mat, a uniform absorption behavior is ensured, and it is therefore possible to optimize the required quantity of absorbing material.

According to the embodiment, the fibers are connected purely mechanically. In particular, no chemical binders such as phenolic resin are necessary. Due to the purely mechanical connection of the fibers, a sound absorption is performed by the insulating element from the beginning without the need to first burn off a binder. In addition, energy can be saved during the manufacturing process since no curing of a binder is necessary.

Preferably, the fibers are connected by needling. In doing so, the fibers are first arranged to form a fleece and are then needled to each other. The sections having differing thicknesses are preferably produced in that in some parts, several layers of fibers are arranged and needled jointly.

Additionally or alternatively, the fibers can be connected by sewing.

The fibers can be mineral fibers, in particular basalt fibers which distinguish themselves by a good absorption capacity and a high thermal stability. The use of glass fibers is also possible.

Individual short fibers can be used for producing the mat, however, the fibers are preferably continuous fibers which are offered in the form of a fiber strand referred to as roving.

In a particular embodiment, the fibers are long fibers cut out from continuous fibers.

To further increase the absorption capacity of the insulating element, the fibers are in particular textured fibers. These are textured before they are arranged in layers or plies and connected to form the mat.

In order to achieve a shape of the insulating element that is adapted to correspond to a respective housing shape of the muffler in a simple and cost-effective manner, the element is configured as punched part. The element is thus punched out from the finished mat.

According to a second aspect of the invention, a muffler is provided which has an outer housing, at least one tube that is arranged in the outer housing and through exhaust gas flows, and at least one insulating element of the type described so far which at least partially surrounds the tube. Here, the tube through which exhaust gas flows need not extend entirely through the outer housing; instead of a continuous tube, it is also possible to provide several partial tubes which are arranged offset relative to each other. The muffler according to the invention can be manufactured cost-effectively and ensures a high absorption capacity even in the case of low temperatures.

The outer housing of the muffler is preferably cylindrical and has two half shells connected to each other. One muffler insulating element can then be inserted into each half shell.

In one example configuration, at least two tubes, which are arranged parallel to each other and through which exhaust gas flows, are provided at least in sections. The tubes are completely surrounded by one or more insulating elements.

The insulating element preferably has a substantially rectangular shape having a central section and two laterally adjoining edge sections. The central section has a larger thickness than the edge sections. Such an insulating element is easy to manufacture and adapts optimally to a muffler having two parallel tubes, with the central section having the larger thickness being arranged between the tubes.

The thickness of the central section amounts in particular to twice the thickness of the edge sections. Of course, any other thickness ratio is also possible, in particular in other muffler shapes.

According to a third aspect of the invention, a method of producing a muffler is provided which is in particular configured as described above. The method comprises the following steps. First, a mat of interconnected fibers is produced which at a constant density has at least two sections of different thicknesses. At least one insulating element in punched out from the mat. The insulating element(s) along with at least one tube is/are then arranged in an outer housing. The method according to the invention is very simple and cost-effective. The muffler thus produced is immediately ready for use; a previously required heating to burn off a chemical binder, for example, is no longer necessary.

In one example, the insulating element is adapted to the shape of at least one section of the outer housing to fill the latter, if possible, entirely and to thus optimize the absorption capacity.

These and other features of the present invention can be best understood from the following specification and drawings, the following of which is a brief description.

### BRIEF DESCRIPTION OF THE DRAWINGS

Further features and advantages of the invention will be apparent from the description below of a embodiment with reference to the enclosed drawings, in which:

FIG. 1 shows a perspective view of a molded part of the prior art used as an insulating element;

FIG. 2 shows a perspective view of a muffler insulating element according to the invention;

FIG. 3 shows a perspective view of the muffler insulating element of FIG. 2 after the adaptation to the housing shape of a muffler according to the invention; and

FIG. 4 shows a perspective sectional view of a muffler according to the invention.

### DETAILED DESCRIPTION OF THE EMBODIMENTS

FIG. 2 shows a muffler insulating element 10 according to the invention which comprises a dimensionally stable mat 12 of interconnected fibers 14 which are mineral fibers, in particular basalt or glass fibers. The mat 12 has a constant density over its entire surface. As can be seen in FIG. 2, the insulating element 10 has a substantially rectangular shape having a central section 16 and two laterally adjoining edge sections 18. The central section 16 has a larger thickness d₁ than the edge sections 18, which here amounts to twice a thickness d₂ of the edge sections 18. The mat 12 also has several sections 16, 18 of different thicknesses d₁ and d₂, respectively. Of course, the mat 12 could also have more sections each having a different thickness.

When manufacturing the insulating element 10, the fibers 14, which are continuous fibers, are first textured, i.e. “inflated” to improve their absorption capacity, and then stacked to form a continuous first fleece layer 20. The continuous fibers can also be cut to long fiber sections before or after texturing. A second fleece layer 22 which is also stacked of fibers 14 is then laid on the first layer 20 of fleece in the central section 16, and the fibers 14 are connected to each other mechanically, for example needled and/or sewn to each other. In doing so, the two layers 20, 22 in the central section 16 are needled or sewn jointly and, if required, more strongly than in the edge sections 18. It has to be noted that the fibers in each fleece layer 20, 22 can also be needled or sewn individually already before the layers 20, 22 are laid one on top of the other. After the stacking, both layers 20, 22 are again needled or sewn jointly. The insulating element 10 is punched out from the mat 12 thus produced as a fleece material. It is of course also possible to lay more than two fleece layers one on top of the other to produce one or more sections having a larger thickness, the individual fleece layers also being adapted to have different strengths.

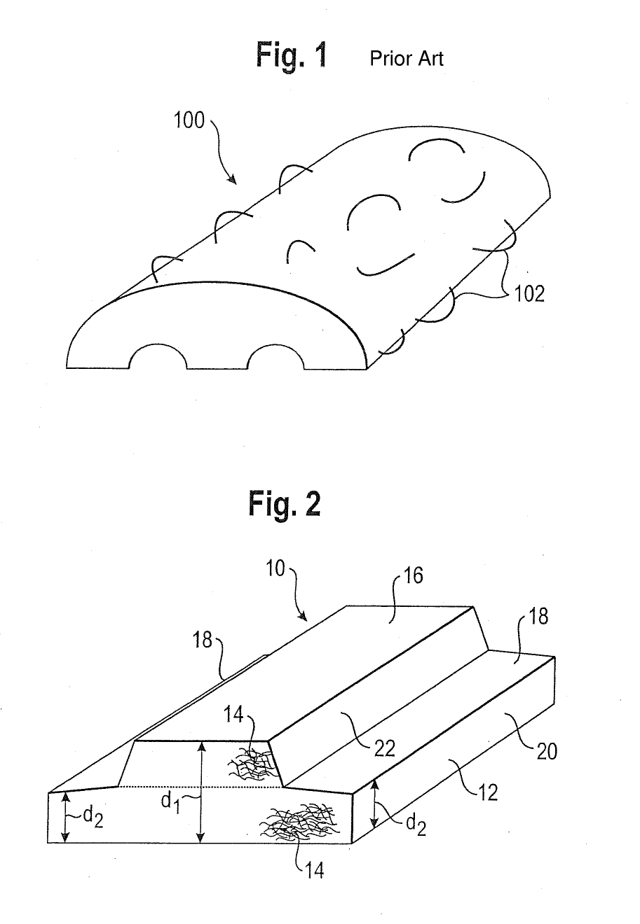

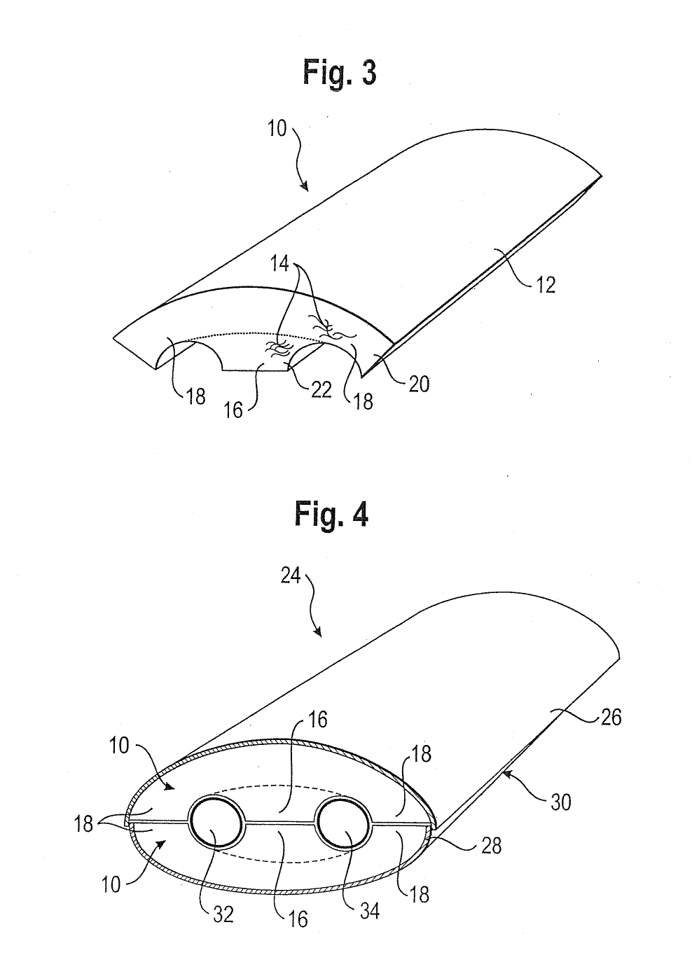

In a subsequent step, the insulating element 10 is adapted to the desired shape of the outer housing (FIG. 3), in the present case by bending the dimensionally stable insulating element 10 into shape. It can be noticed that in comparison with the molded part 100 known from the prior art (cf. FIG. 1), the insulating element 10 distinguishes itself by a smooth contour having no projecting fibers.

FIG. 4 shows a muffler 24 according to the invention in the mounted state which has a cylindrical outer housing 30 which is formed by two half shells 26, 28 that are connected to each other and has an oval cross-sectional area. Two tubes 32, 34 which are arranged parallel to each other and through which exhaust gas flows are housed in the outer housing 30 in the longitudinal direction. The remaining interior of the outer housing 30 is filled by two identical insulating elements 10 which are arranged in a mirror-inverted manner and are mounted in the outer housing 30 along with the tubes 32, 34. As can be seen in FIG. 4, the central section 16 of both insulating elements 10 is arranged between the tubes 32 and 34.

It is of course also conceivable that instead of the entire muffler 24, merely a section of the muffler is configured as absorption muffler and further chambers are provided in the common outer housing which serve as reflection chambers, for example. In this case, only the absorption section of the muffler is provided with the insulating element 10.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A muffler insulating element comprising:
a mat of interconnected fibers,
the mat having a constant density and at least two sections of different thicknesses.

2. The muffler insulating element according to claim 1, wherein the interconnected fibers are connected purely mechanically.

3. The muffler insulating element according to claim 1, wherein the interconnected fibers are connected by needling.

4. The muffler insulating element according to claim 1, wherein the interconnected fibers are connected by sewing.

5. The muffler insulating element according to claim 1, wherein the interconnected fibers are mineral fibers.

6. The muffler insulating element according to claim 1, wherein the interconnected fibers are basalt fibers.

7. The muffler insulating element according to claim 1, wherein the interconnected fibers are glass fibers.

8. The muffler insulating element according to claim 1, wherein the interconnected fibers are continuous fibers.

9. The muffler insulating element according to claim 1, wherein the interconnected fibers are long fibers cut from continuous fibers.

10. The muffler insulating element according to claim 1, wherein the interconnected fibers are textured fibers.

11. The muffler insulating element according to claim 1, wherein the muffler insulating element is a punched part.

12. A muffler including:
an outer housing;
at least one tube which is arranged in the outer housing and through which exhaust gas flows; and
at least one insulating element at least partially surrounding the at least one tube, and wherein the at least one insulating element comprises a mat of interconnected fibers, the mat, having a constant density at least two sections of different thicknesses.

13. The muffler according to claim 12, wherein the outer housing is cylindrical and has two half shells connected to each other.

14. The muffler according to claim 12, wherein the at least one tube comprises at least two tubes arranged parallel to each other and through which exhaust gas flows.

15. The muffler according to any of claim 12, wherein the at least one insulating element has a substantially rectangular shape having a central section and two laterally adjoining edge sections, the central section having a larger thickness than the edge sections.

16. The muffler according to claim 15, wherein the thickness of the central section amounts to twice the thickness of the edge sections.

17. A method of producing a muffler comprising the following steps:
producing a mat consisting of interconnected fibers which has a constant density and at least two sections of different thicknesses;
punching out at least one insulating element from the mat; and
arranging the at least one insulating element along with at least one tube in an outer housing.

18. The method according to claim 17, including adapting the at least one insulating element to a shape of at least one section of the outer housing.
